(19) United States
(12) Patent Application Publication
(10) Pub. No.: US 2026/0148990 A1
(43) Pub. Date: May 28, 2026

(54) BINDER FOR NEGATIVE ELECTRODE OF RECHARGEABLE LITHIUM BATTERY, NEGATIVE ELECTRODE FOR RECHARGEABLE LITHIUM BATTERY INCLUDING BINDER, AND RECHARGEABLE LITHIUM BATTERY INCLUDING NEGATIVE ELECTRODE

(71) Applicant: SAMSUNG SDI CO., LTD., Yongin-si (KR)

(72) Inventor: Mobeom YI, Yongin-si (KR)

(73) Assignee: SAMSUNG SDI CO., LTD., Yongin-si (KR)

(21) Appl. No.: 19/400,105

(22) Filed: Nov. 25, 2025

(30) Foreign Application Priority Data
Nov. 28, 2024 (KR) 10-2024-0174123

(51) Int. Cl. H01M 4/62; C08F 290/04; H01M 4/02; H01M 4/133; H01M 4/587; H01M 10/0525

(52) U.S. Cl. CPC H01M 4/622; C08F 290/046; H01M 4/133; H01M 4/587; H01M 10/0525; H01M 2004/027

(57) ABSTRACT

Disclosed are a binder for a negative electrode of a rechargeable lithium battery, a negative electrode including the binder, and a rechargeable lithium battery including the negative electrode. The binder for the negative electrode includes a brush-like polymer.

### CROSS-REFERENCE TO RELATED APPLICATION

This application claims priority to Korean Patent Application No. 10-2024-0174123 filed with the Korean Intellectual Property Office on Nov. 28, 2024, the entire contents of which are incorporated herein by reference.

### BACKGROUND

### (a) Field

Example embodiments relate to a binder for a negative electrode of a rechargeable lithium battery, a negative electrode for a rechargeable lithium battery including the binder, and a rechargeable lithium battery including the negative electrode.

### (b) Description of the Related Art

With increasing presence of electronic devices that use batteries such as, e.g., mobile phones, laptop computers, electric vehicles, and the like, demand for high-energy density and high-capacity rechargeable lithium batteries is increasing. Thus, improving the performance of rechargeable lithium batteries may be advantageous.

Rechargeable lithium batteries include a positive electrode and a negative electrode having an active material capable of intercalating and deintercalating lithium ions, and an electrolyte solution, and electrical energy is produced by oxidation and reduction reactions when lithium ions are intercalated/deintercalated at the positive and negative electrodes.

### SUMMARY

One or more example embodiments include a binder for a negative electrode of a rechargeable lithium battery exhibiting desired or improved dispersibility and an adhesion, and high elasticity properties, thereby exhibiting desired or improved durability.

Another example embodiment includes a negative electrode for a rechargeable lithium battery including the binder.

Still another example embodiment includes a rechargeable lithium battery including the negative electrode.

One or more example embodiments include a binder for a negative electrode of a rechargeable lithium battery including a brush-like copolymer represented by Chemical Formula 1 below.

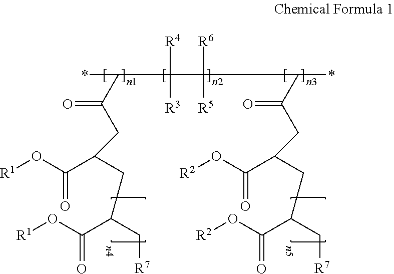

In Chemical Formula 1, R¹ and R² are the same or different, and are or independently include hydrogen; or a substituted or unsubstituted alkyl group,
R³ to R⁶ are the same or different, and are or independently include hydrogen; a substituted or unsubstituted alkyl group; or R^{a}COOR^{b}, wherein R^{a} is a substituted or unsubstituted alkylene group and R^{b} is a substituted or unsubstituted alkyl group,
R⁷ is hydrogen; a substituted or unsubstituted alkyl group; or CR^{d}R^{e}COOR^{f}, wherein R^{d}, R^{e}, and Rf are the same or different and are or independently include hydrogen; or an alkyl group,
n1 is an integer in a range of about 1 to about 10,
n2 is an integer in a range of about 2 to about 500,
n3 is an integer in a range of about 1 to about 10, and
n4 and n5 are each an integer in a range of about 10 to about 100.

Another example embodiment includes a negative electrode for a rechargeable lithium battery including a negative electrode active material layer including the binder and a negative electrode active material.

Still another example embodiment includes a rechargeable lithium battery including a negative electrode including a negative electrode active material layer including the binder and a negative electrode active material; a positive electrode; and a non-aqueous electrolyte.

The binder for a negative electrode for a rechargeable lithium battery according to one or more example embodiments may have a desired or improved dispersibility and adhesion, and exhibit high elasticity, and thus, the battery including the binder may exhibit a desired or improved durability during repeated charging and discharging.

### BRIEF DESCRIPTION OF THE DRAWINGS

FIG. 1 to FIG. 4 are cross-sectional views schematically showing rechargeable lithium batteries according to some example embodiments.

### DETAILED DESCRIPTION

Hereinafter, example embodiments are described in detail. However, these embodiments are examples, the present disclosure is not limited thereto and the present disclosure is defined by the scope of claims.

As used herein, when a specific definition is not otherwise provided, it is understood that when an element such as a layer, film, region, or substrate is referred to as being“on” another element, the element may be “directly on” the other element, or intervening elements may also be present.

Unless otherwise specified in this specification, what is indicated in the singular may also include the plural. In addition, unless otherwise specified, “A or B” may mean “including A, including B, or including A and B.”

As used herein, “the term “combination thereof may include a mixture, a laminate, a complex, a copolymer, an alloy, a blend, a reactant of constituents.

In the present disclosure, when a definition is not otherwise provided, a particle diameter may be an average particle diameter. The particle diameter indicates an average particle diameter (D50) where a cumulative volume is about 50 volume % in a particle size distribution. The average particle diameter (D50) may be measured by a method well known to those skilled in the art, for example, by a particle size analyzer, or by a transmission electron microscope (TEM) image, or a scanning electron microscope (SEM) image. In some example embodiments, a dynamic light-scattering measurement device is used to perform a data analysis, and the number of particles is counted for each particle size range, and from this, the average particle diameter (D50) value may be readily obtained through a calculation. The average particle diameter (D50) may be measured by a laser diffraction method. The laser diffraction may be performed by distributing particles to be measured in a distribution solvent, and introducing the particles to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50 volume % standard of particle size distribution in the measuring device.

In some example embodiments, an average particle diameter may be measured by various techniques, and for example, may be measured by a particle size analyzer.

In some example embodiments, a thickness may be measured by a SEM or a TEM image for the cross-section, but the measurement technique is not limited thereto, and the thickness may be measured by any technique, as long as the technique may measure the thickness in the related arts. The thickness may be an average thickness.

As used herein, soft carbon refers to graphitizable carbon materials that are readily graphitized by heat treatment at a high temperature, e.g., about 2800° C., and hard carbon refers to non-graphitizable carbon materials that are not substantially, or that are only slightly, graphitized by heat treatment. The terms soft carbon and hard carbon may be well known in the related arts.

In some example embodiments, the crystalline carbon and the amorphous carbon may be distinguished through XRD measurement. The crystalline carbon includes natural graphite and artificial graphite. Natural graphite may indicate graphite which may be naturally generated by separating the graphite from minerals, and when measured by XRD, the interplanar spacing (d002) of the (002) plane may be in a range of about 3.350 Å to about 3.360 Å. Artificial graphite may indicate graphite manufactured by graphitization, and when measured by XRD, the interplanar spacing (d002) of the (002) plane may be in a range of about 3.355 Å to about 3.365 Å. Meanwhile, the amorphous carbon may have the interplanar spacing (d 002) of the (002) plane of about 3.34 Å or less, when measured by XRD. The XRD may be measured using CuKα ray as a target line with an X-ray diffraction analyzer (e.g., product name: X'Pert, manufacturer: Malvern Panalytical) and by removing a monochromator to improve a peak density resolution. The measurement condition may be 2θ=10° to 80° a scan speed (°/S) of 0.044 to 0.089, and a step size (°/step) of 0.013 to 0.039.

In some example embodiments, a weight-average-molecular weight may be measured by using gel permeation chromatography (GPC).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

A binder for a negative electrode of a rechargeable lithium battery includes a brush-like copolymer represented by Chemical Formula 1 below.

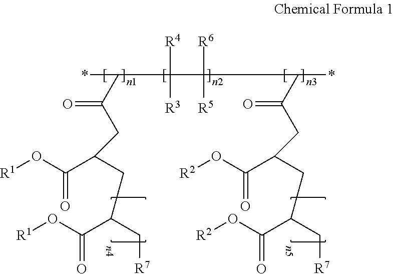

In Chemical Formula 1, R¹ and R² are the same or different, and are or independently include hydrogen; or a substituted or unsubstituted alkyl group. In one or more example embodiments, the R¹ and the R² may be the same or different and may be or independently include an unsubstituted alkyl group. The alkyl group may be or include a C1 to C15 alkyl group, a C1 to C10 alkyl group, or a C1 to C4 alkyl group. The alkyl group may be or include a linear alkyl group or a branched alkyl group.

In Chemical Formula 1, R³ to R⁶ are the same or different, and are or independently include hydrogen; a substituted or unsubstituted alkyl group; or R^{a}COOR^{b}, wherein R^{a} is a substituted or unsubstituted alkylene group and R^{b} is a substituted or unsubstituted alkyl group. In Chemical Formula 1, R⁷ is or includes hydrogen, a substituted or unsubstituted alkyl group; or CR^{d}R^{e}COOR^{f}, wherein R^{d}, R^{e}, and Rf are the same or different and are or independently include hydrogen; or an alkyl group. The alkylene group may be or include a C1 to C15 alkylene group, a C1 to C10 alkylene group, or a C1 to C4 alkylene group. The alkyl group may be or include a C1 to C15 alkyl group, a C1 to C10 alkyl group, or a C1 to C4 alkyl group. The alkylene group or the alkyl group may be or include a linear alkylene group or alkyl group or a branched alkylene group or alkyl group.

According to one or more example embodiments, in the substituted alkyl group or in the substituted alkylene, the substituent may be or include a hydroxy group, a methyl group, a hydrogen, or an amine group.
n1 is an integer in a range of about 1 to about 10, or may be an integer in a range of about 1 to about 5, or an integer in a range of about 1 to about 3.
n3 is an integer in a range of about 1 to about 10, or may be an integer in a range of about 1 to about 5, or an integer in a range of about 1 to about 3.
n2 represents a gap between the brush-like polymers, and is an integer in a range of about 2 to about 500, or may be an integer in a range of about 10 to about 500, or an integer in a range of about 10 to about 100. When n2 is within the above range, a desired or improved elastic force and adhesive strength of the binder may be exhibited. When n2 is out of the above range, the thickness change of the rechargeable lithium battery after charging and discharging is increased, which is not desirable.
n4 and n5 are each an integer in a range of about 10 to about 100, or may be an integer in a range of about 10 to about 30. n4 and the n5 corresponds to side chains bonded to the main chain, and a polymer with the side chain having a length corresponding to n4 and n5 may be called a “brush type” polymer. In one or more example embodiments, the length corresponding to n4 and n5, which are the side chain, may provide steric hindrance of the chain movement and reduce or suppress an entanglement of chains. When the entanglement of polymer chains occurs in the binder, decreases in elasticity and plastic deformation may be caused when stress or elongation occur. However, the binder according to one or more example embodiments does not cause chain entanglement, resulting in improvements in the elasticity properties of the binder and no or substantially no occurrence of plastic deformation.

In one or more embodiments, a weight-average molecular weight (Mw) of the binder may be about 100 kDa to about 5 MDa, about 100 kDa to about 2 MDa, or about 100 kDa to about 1 MDa. When the weight-average molecular weight (Mw) of the binder satisfies the range, desired or improved adhesion and elasticity may be exhibited.

A preparation for the binder for the negative electrode according to one or more example embodiments is not limited, and the binder may be synthesized by any procedures generally known in the related arts. The binder according to one or more example embodiments may be prepared by the following procedures.

A monomer is firstly subjected to an ATRP (Atom Transfer Radical Polymerization) reaction to prepare a halogen-including intermediate and the halogen-including intermediate is subjected to a halogen substitution reaction to prepare a macro monomer which is a side chain.

The ATRP reaction may be carried out by using a halogen-including initiator, a ligand, and a catalyst, together with the monomer. In the ATRP reaction, a mixing ratio of the monomer, the halogen-including initiator, and the ligand may be in a range of about 1:about 0.01 to about 0.1:about 0.012 to about 0.6 by mole ratio, or about 1:about 0.01 to about 0.06:about 0.02 to about 0.12 by mole ratio. When the mixing ratio of the monomer, the halogen-including initiator, and the ligand is included in the above range, the advantages related to the low PDI (poly-dispersity index) of the macro monomer may be obtained.

The catalyst may be used at a suitable amount in order to initiate the ATRP reaction and for example, may be in a range of about 0.01 wt % to about 0.1 wt %, about 0.01 wt % to about 0.05 wt %, or about 0.01 wt % to about 0.02 wt % based on 100 wt % of the initiator.

The monomer may be or include at least one of ethyl acrylate, butyl acrylate, 2-hydroxyl acrylate, acrylic acid, 2-ethylhexyl acrylate, isobornyl acrylate, or a combination thereof.

The halogen-including initiator may be or include, for example, at least one of ethyl 2-bromo-2-methyl propionate, methyl 2-bromo-2-methyl propionate, 2-hydroxyethyl 2-bromoisobutyrate, 2-bromo-2-methylpropionic acid, or a combination thereof.

By using an initiator including halogen as the initiator, a halogen substitution reaction in which halogen is substituted with an acryl group may be induced, thereby generating a macro monomer.

The ligand may be or include at least one of N,N,N′,N″,N″-pentamethyldiethylenetriamine, tris2-(dimethylamino)ethylamine, tris (2-aminoethyl)amine, tris (3-aminopropyl)amine, or a combination thereof.

The catalyst may be or include at least one of Cu, Fe, or Sn.

The halogen substitution reaction may be carried out by using a potassium salt, and the potassium salt may be or include at least one of potassium propanoate (propane acid potassium salt), potassium acrylate (acrylic acid potassium), potassium (meth)acrylate ((meth)acrylic acid potassium), or a combination thereof. For example, the halogen substitution reaction may be carried out by mixing the halogen-including intermediate and the potassium salt. Herein, the mixing ratio of the halogen-including intermediate and the potassium salt may be in a range of about 1:1 to about 1:5 by weight ratio, or about 1:1 to about 1:2 by weight ratio.

When the macro monomer preparation is illustrated as a reaction scheme, for example, using butyl acrylate as a monomer, ethyl 2-bromo-2-methyl propionate as the initiator, the macro monomer preparation is as follows.

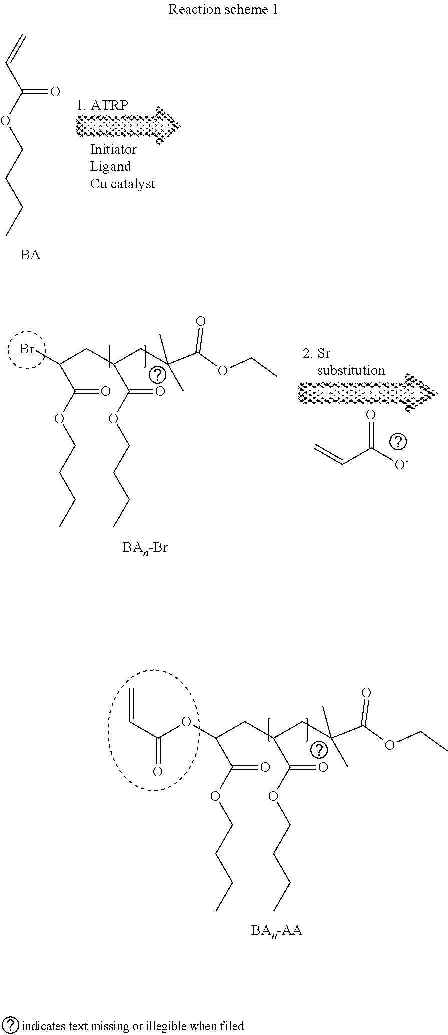

As shown in the reaction scheme 1, the butyl acrylate is subjected into the ATRP reaction to prepare BAₙ-Br, and this is subjected into the halogen substitution reaction, for example, is reacted with potassium acrylate, thereby preparing a macro monomer BAₙ-AA which is a side chain.

The macro monomer and a monomer having a double bond are copolymerized via a free radical reaction to prepare a binder according to one or more example embodiments. Herein, the controls for n1, n2, n3 in Chemical Formula 1 depend on the mixing ratio of the macro monomer and the monomer having the double bond.

In one or more example embodiments, the mixing ratio of the macro monomer and the monomer having the double bond may be in a range of about 1:2 by mole ratio to about 1:500 by mole ratio, or about 1:2 by mole ratio to about 1:100 by mole ratio. When the mixing ratio of the macro monomer and the monomer having the double bond is within the above range, the desired brush-like copolymer represented by Chemical Formula 1 may be prepared as desired. For example, when the mixing ratio of the macro monomer and the monomer having the double bond is about 1:2 by mole ratio, a copolymer having n1 of 1, n2 of 2, and n3 of 1 in Chemical Formula 1 may be prepared.

In one or more example embodiment, since the free radical reaction is utilized, various monomers, e.g., monomers having the double bond, may be used, and thus, the free radical reaction may be economical.

The monomer having the double bond may be or include at least one of ethyl acrylate, butyl acrylate, 2-ethylhexyl acrylate, 2-hydroxyethyl acrylate, acrylic acid, or a combination thereof.

The mixing ratio of the macro monomer and the monomer having the double bond may be in a range of about 1:2 to about 1:500 by a mole ratio, or about 1:2 to about 1:100 by mole ratio. When the mixing ratio of the macro monomer and the monomer having double bonds is within the above range, the flexibility and the adhesion may be improved.

### Negative Electrode for Rechargeable Lithium Battery:

The negative electrode according to one or more example embodiments includes a negative electrode active material layer including a binder, and a negative electrode active material. The binder may be or include the binder according to one or more example embodiments.

In one or more example embodiments, an amount of the binder may be, based on the total weight of the negative electrode active material layer, in a range of about 1 wt % to about 5 wt %, about 1 wt % to about 3 wt %, or about 1 wt % to about 2 wt %. When the amount of the binder is within the above range, the negative electrode active materials may be sufficiently attached to each other, the negative electrode active material layer may be sufficiently adhered to the current collector, and a desired or improved restoration force against the volume expansion of the negative electrode active material may be provided.

The negative electrode active material may be or include a Si-based negative electrode active material. The Si-based negative electrode active material has a substantially high capacity, but has shortcomings including severe expansion and shrinkage of volume during charging and discharging, and these shortcomings may be effectively removed by using the Si-based negative electrode active material together with the binder according to one or more example embodiments. Accordingly, the negative electrode according to one or more example embodiments may satisfy both high-capacity, owing to the utilization of the Si-based negative electrode active material, and desired or improved cycle-life characteristics, owing to the binder according to one or more example embodiments.

The Si-based negative electrode active material may be or include at least one of silicon, a Si—C composite, SiOₓ (0<x≤2), a Si-Q alloy (wherein Q is an element such as or including at least one of an alkali metal, an alkaline-earth metal, a Group 13 element, a Group 14 element (except for Si) a Group 15 element, a Group 16 element, a transition metal, a rare earth element, and a combination thereof), or a combination thereof.

The Si-based negative electrode active material may be or include silicon or the silicon-carbon composite.

The silicon-carbon composite may be or include a composite of silicon and amorphous carbon. According to one or more example embodiments, the silicon-carbon composite may include silicon particles, and an amorphous carbon coated on the surface of the silicon particle. For example, the silicon-carbon composite may include a secondary particle (core) in which silicon primary particles are agglomerated, and an amorphous carbon coating layer (shell) on the secondary particle. The amorphous carbon is also present between the silicon primary particles, for example, to coat the silicon primary particles. For example, the secondary particle may also be distributed in an amorphous carbon matrix.

Furthermore, the silicon-carbon composite may include silicon particles, and an amorphous carbon coating layer on the surface of the silicon particles.

The secondary particles are positioned at the center of the Si—C composite, so the secondary particles may be referred to as a core or a center part. The amorphous carbon coating layer may be referred to as an outer part or a shell.

The silicon particles may be or include nano silicon particles. The nano silicon particles may have an average particle diameter in a range of about 10 nm to about 1000 nm, and according to one or more example embodiments, the average particle diameter of the nano silicon particles may be in a range of about 20 nm to about 900 nm, about 20 nm to about 500 nm, about 20 nm to about 300 nm, or about 20 nm to about 150 nm. When the average particle diameter of the silicon particles is within the above range, the substantial volume expansion caused during charge and discharge may be reduced or suppressed, and a breakage of the conductive path due to crushing of particle during charging and discharging may be reduced or prevented.

A mixing ratio of the nano silicon particles and the amorphous carbon may be in a range of about 20:80 to about 70:30 by weight ratio.

In one or more example embodiments, the silicon-carbon composite may further include crystalline carbon. In some example embodiments, the silicon-carbon composite may include a core including crystalline carbon and silicon particles, and an amorphous carbon coating layer on a surface of the core.

When the silicon-carbon composite includes the silicon particles, the crystalline carbon, and the amorphous carbon, an amount of the amorphous carbon may be in a range of about 10 wt % to about 70 wt % based on the total 100 wt % of the silicon-carbon composite, and an amount of the crystalline carbon may be in a range of about 10 wt % to about 70 wt % based on the total 100 wt % of the silicon-carbon composite. An amount of the silicon particle may be, based on the total 100 wt % of the silicon-carbon composite, in a range of about 20 wt % to about 69 wt %, and according to one or more example embodiments, may be in a range of about 30 wt % to about 60 wt %.

The particle diameter of the silicon-carbon composite may be adjusted as desired, and the particle diameter is not particularly limited thereto.

When the amorphous carbon is present surrounding the surface of the secondary particles, the thickness thereof may be adjusted as desired, but may exist, for example, at a thickness in a range of about 5 nm to about 100 nm.

In one or more example embodiments, the negative electrode active material layer may further include a conductive material.

For example, the negative electrode active material layer may include the negative electrode active material in a range of about 95 wt % to about 99 wt % and the binder of about 1 wt % to about 5 wt %, and in another example embodiments, the negative electrode active material layer may include the negative electrode active material in a range of about 91.5 wt % to about 99 wt %, the binder of about 1 wt % to about 5 wt %, and the conductive material in a range of about 0.5 wt % to about 5 wt %. The binder may be or include the binder according to one or more example embodiments, or a mixture of the binder according to one or more example embodiments and an aqueous binder.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinyl pyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

The conductive material is included to provide electrode conductivity, and any electrically conductive material may be used as a conductive material unless the electrically conductive material causes an adverse chemical change in the battery. Examples of the conductive material may be or include a carbon-based material such as at least one of natural graphite, artificial graphite, carbon black, acetylene black, ketjen black, a carbon fiber, a carbon nanofiber, carbon nanotube, or the like; a metal-based material of a metal powder or a metal fiber including at least one of copper, nickel, aluminum, silver, and the like; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, and a combination thereof.

### Rechargeable Lithium Battery:

Other example embodiments include a rechargeable lithium battery including the negative electrode, a positive electrode, and a non-aqueous electrolyte.

### Positive Electrode:

The positive electrode may include a current collector, and a positive electrode active material layer on the current collector. The positive electrode active material layer includes a positive electrode active material, and may further include a binder and/or a conductive material.

For example, the positive electrode may further include an additive that may be configured as a sacrificial positive electrode.

An amount of the positive active material may be in a range of about 90 wt % to about 99.5 wt % based on 100 wt % of the positive active material layer, and amounts of the binder and the conductive material may be respectively in a range of 0.5 wt % to 5 wt % based on 100 wt % of the positive active material layer.

The positive active material may include a compound (lithiated intercalation compound) that is capable of intercalating and deintercalating lithium. In some example embodiments, at least one of a composite oxide of lithium and a metal such as or including at least one of cobalt, manganese, nickel, or combinations thereof may be included.

The composite oxide may be or include a lithium transition metal composite oxide, and examples thereof may include at least one of lithium nickel-based oxide, lithium cobalt-based oxide, lithium manganese-based oxide, lithium iron phosphate-based compound, cobalt-free lithium nickel-manganese-based oxide, or a combination thereof.

For example, the following compounds represented by any one of the following chemical formulas may be included. LiaA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel amount that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may achieve high capacity, and may be applicable to a high-capacity, high-density rechargeable lithium battery.

The binder is configured to improve binding properties of positive electrode active material particles with one another and with a current collector. Examples of the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, or the like, but are not limited thereto.

The conductive material is included to provide electrode conductivity, and any suitable electrically conductive material may be included as a conductive material, unless the electrically conductive material causes an adverse chemical change in the battery. Examples of the conductive material may include a carbon-based material such as or including at least one of natural graphite, artificial graphite, carbon black, acetylene black, Ketjen black, carbon fiber, carbon nanofiber, carbon nanotube, or the like; a metal-based material of a metal powder or a metal fiber including at least one of copper, nickel, aluminum, silver, or the like; a conductive polymer such as a polyphenylene derivative; or a mixture thereof.

The current collector may include Al, but is not limited thereto.

### Electrolyte:

The electrolyte for a rechargeable lithium battery may include a non-aqueous organic solvent and a lithium salt.

The non-aqueous organic solvent is configured as a medium that transmits ions taking part in the electrochemical reaction of a battery.

The non-aqueous organic solvent may include at least one of a carbonate-based, ester-based, ether-based, ketone-based, alcohol-based, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include at least one of methyl acetate, ethyl acetate, n-propyl acetate, dimethyl acetate, methyl propionate, ethyl propionate, decanolide, γ-butyrolactone, mevalonolactone, valerolactone, caprolactone, or the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, or the like. The ketone-based solvent may include cyclohexanone, or the like. The alcohol-based solvent may include at least one of ethanol, isopropyl alcohol, and the like. The aprotic solvent may include at least one of nitriles such as R—CN (wherein R is or includes a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, and the like; sulfolanes, or the like.

The organic solvent may be included alone or in a mixture of two or more solvents.

When the carbonate-based solvent is included, the cyclic carbonate and the linear carbonate may be included together therewith, and the cyclic carbonate and the linear carbonate may be mixed at a volume ratio in a range of about 1:1 to about 1:9.

The electrolyte may further include at least one of vinylethyl carbonate, vinylene carbonate, difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or a combination thereof, as an additive.

The lithium salt dissolved in an organic solvent is configured to supply a battery with lithium ions, to operate the rechargeable lithium battery, and to improve transportation of the lithium ions between positive and negative electrodes. Examples of the lithium salt include one, or at least two, supporting electrolyte salts such as or including at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y are an integer in a range of 1 to 20, lithium trifluoromethane sulfonate, lithium tetrafluoroethane sulfonate, lithium difluorobis(oxalato)phosphate (LiDFBOP), and lithium bis(oxalato) borate (LiBOB).

### Separator:

A separator may be present between the positive electrode and the negative electrode, depending on a type of rechargeable lithium battery. The separator may include at least one of polyethylene, polypropylene, polyvinylidene fluoride or multi-layers thereof having two or more layers and may be or include a mixed together multilayer such as a polyethylene/polypropylene double-layered separator, a polyethylene/polypropylene/polyethylene triple-layered separator, a polypropylene/polyethylene/polypropylene triple-layered separator, and the like.

The separator may include a porous substrate and a coating layer including an organic material, an inorganic material, or a combination thereof, on one surface, or on both surfaces (e.g., one or two opposing surfaces), of the porous substrate.

The porous substrate may be or include a film formed of or including any one or more of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acryl-based polymer.

The inorganic material may be or include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed in one coating layer, or a coating layer including an organic material and a coating layer including an inorganic material may be stacked together.

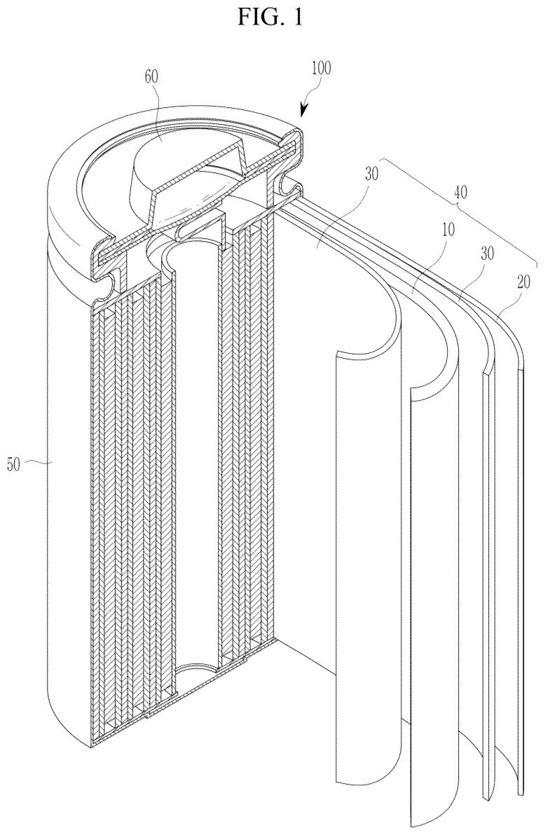

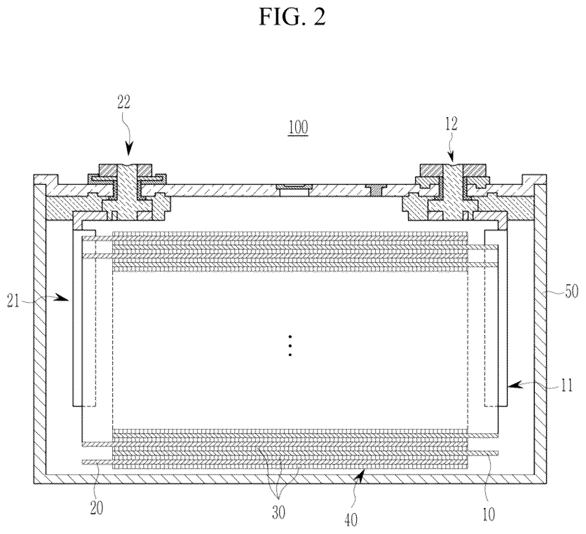

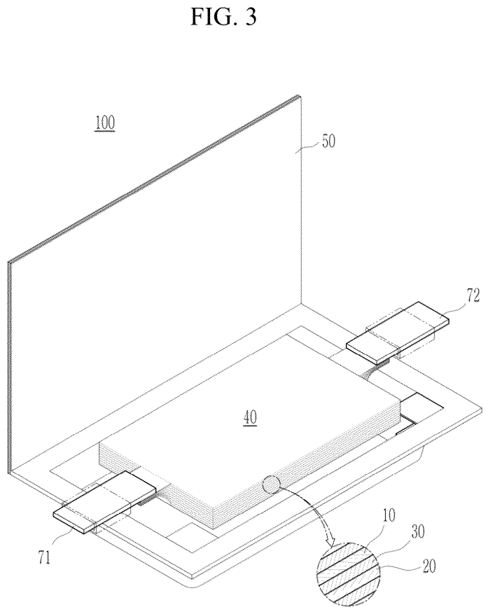

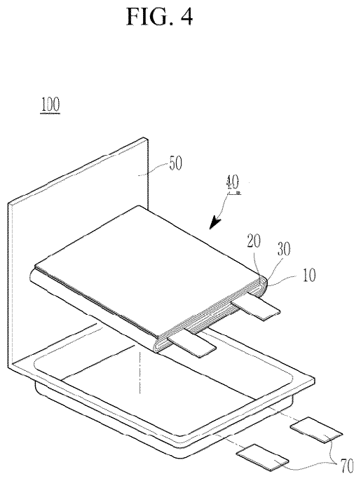

The rechargeable lithium battery may be classified into cylindrical, prismatic, pouch, or coin-type batteries, and the like depending on the shape thereof. FIG. 1 to FIG. 4 are schematic views illustrating a rechargeable lithium battery according to example embodiments, and FIG. 1 shows a cylindrical battery, FIG. 2 shows a prismatic battery, and FIG. 3 and FIG. 4 show pouch-type batteries. Referring to FIG. 1 to FIG. 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte (not shown). The rechargeable lithium battery 100 may include a sealing member 60 that seals the case 50, as shown in FIG. 1. In FIG. 2, the rechargeable lithium battery 100 may include a positive electrode lead tab 11 and a positive terminal 12 connected to the positive electrode lead tab 11, a negative electrode lead tab 21, and a negative terminal 22 connected to the negative electrode lead tab 21. As shown in FIG. 4, the rechargeable lithium battery 100 may include an electrode tab 70, which may form an electrical path for inducing the current formed in the electrode assembly 40 to the outside of the rechargeable lithium battery 100, or a positive electrode tab 71 and a negative electrode tab 72, as shown in FIG. 3.

The rechargeable lithium battery according to an example embodiment may be applicable to, e.g., automobiles, mobile phones, and/or various suitable types of electric devices, as non-limiting examples.

The following Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Example.

### Example 1

### 1) Preparation of Binder

A macro monomer was prepared as shown in reaction scheme 1 below.

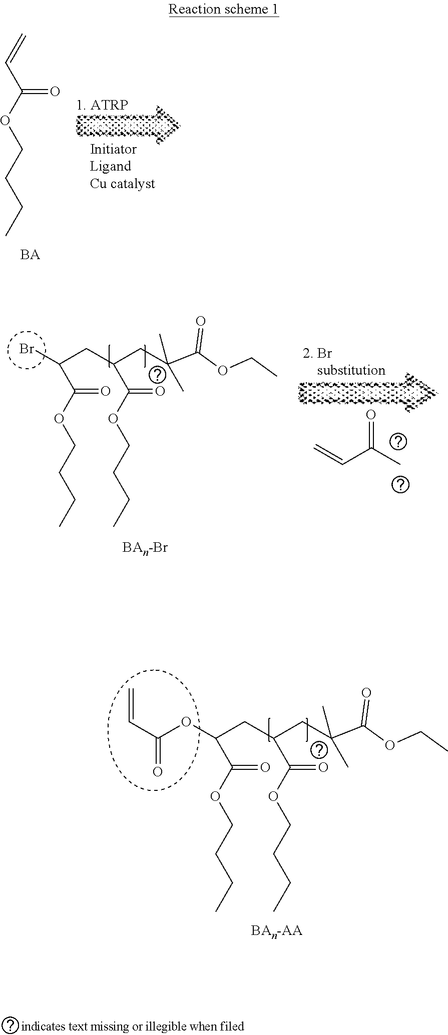

Butyl acrylate, an ethyl 2-bromo-2-methylpropionate initiator, and tris2-(dimethylamino)ethylamine ligand at a mole ratio of 1:0.05:0.06 were subjected to an ATRP reaction in a presence of a Cu catalyst to prepare a BAₙ-Br. An amount of the Cu catalyst was 0.1 wt % based on 100 wt % of the initiator. The BAₙ-Br and potassium propanoate at a weight ratio of 1:2 were subjected to the halogen substitution reaction to prepare a macro monomer BAₙ-AA being a side chain.

The macro monomer and the butyl acrylate monomer at a mole ratio of 1:2 was subjected to a copolymerization via the free radical reaction to prepare a brush-like binder having a polymer structure of Chemical Formula 1 below (weight-average molecular weight (Mw): 1 MDa).

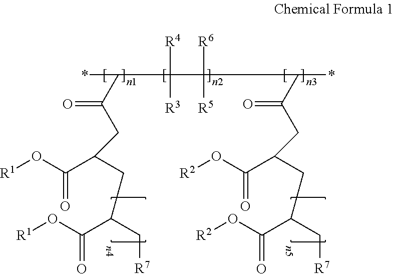

In Chemical Formula 1, R¹ and R² are identically butyl,
R³ to R⁶ are identically CH₂CH₂COOCH₂CH₃,
R⁷ is C(CH₃)₂COOCH₂CH₃,
n1 is an integer of 1,
n2 is an integer of 10,
n3 is an integer of 1,
n4 and n5 are independently an integer of 20.

A silicon negative electrode active material constituting 98 wt % of a negative electrode active material layer slurry and the binder constituting 2 wt % of the negative electrode active material layer slurry were mixed in a water solvent to prepare the negative electrode active material layer slurry with the solid content of 55 wt %.

The negative electrode active material layer slurry was coated on a copper current collector and dried followed by pressurizing, thereby preparing a negative electrode.

A LiNi_{0.8}Co_{0.1}Mn_{0.1}O₂ positive electrode active material constituting 96 wt % of a positive electrode active material layer slurry, Ketjen black constituting 2 wt % of the positive electrode active material layer slurry, and polyvinylidene fluoride constituting 2 wt % of the positive electrode active material layer slurry were mixed in an N-methyl pyrrolidone solvent to prepare the positive electrode active material layer slurry. The positive electrode active material layer slurry was coated on an Al foil current collector and dried followed by pressurizing, thereby preparing a positive electrode.

The negative electrode, the positive electrode, and an electrolyte were used to fabricate a full cell. As the electrolyte, a 1.15M LiPF₆ dissolved in ethylene carbonate, ethylmethyl carbonate, and dimethyl carbonate (3:5:2 by volume ratio) was used.

### Example 2

A binder (weight-average molecular weight: 1 MDa) in which n2 being the gap between the brush-like polymer was equal to 50 in Chemical Formula 1 was prepared by the same procedure as in Example 1, with a difference that a mixing ratio of the macro monomer and the butyl acrylate monomer was changed to 1:50 by mole ratio.

A full cell was prepared by the same procedure as in Example 1 using the binder.

### Example 3

A binder (weight-average molecular weight: 1 MDa) in which n2 being the gap between the brush-like polymer was equal to 100 in Chemical Formula 1 was prepared by the same procedure as in Example 1, with a difference that a mixing ratio of the macro monomer and the butyl acrylate monomer was changed to 1:100 by mole ratio.

A full cell was prepared by the same procedure as in Example 1 using the binder.

### Example 4

A binder (weight-average molecular weight: 1 MDa) in which n2 being the gap between the brush-like polymer was equal to 500 in Chemical Formula 1 was prepared by the same procedure as in Example 1, with a difference that a mixing ratio of the macro monomer and the butyl acrylate monomer was changed to 1:500 by mole ratio.

A full cell was prepared by the same procedure as in Example 1 using the binder.

### Comparative Example 1

A binder (weight-average molecular weight: 1 MDa) in which n2 being the gap between the brush-like polymer was equal to 1 in Chemical Formula 1 was prepared by the same procedure as in Example 1, with a difference that a mixing ratio of the macro monomer and the butyl acrylate monomer was changed to 1:1 by mole ratio.

A full cell was prepared by the same procedure as in Example 1 using the binder.

### Experimental Example 1) Evaluation of Modulus

The shear modulus for the binders according to the Examples 1 to 4 and Comparative Example 1 was measured at a frequency of 0.01 Hz to 100 Hz under a 0.1% strain condition after coating the binder at a thickness of 300 μm on the flat planar plate with the diameter of 8p. Among these results, the modulus result obtained at 10 Hz are shown in Table 1 below.

TABLE 1

| | n2 | Modulus (kPa, 10 Hz) |
|---|---|---|
| Example 1 | 10 | 25 |
| Example 2 | 50 | 40 |
| Example 3 | 100 | 70 |
| Example 4 | 500 | 100 |
| Comparative Example 1 | 1 | 15 |

As shown in Table 1, the binders according to Examples 1 to 4 in which the n2 was equal to 10 to 500 exhibited a suitable modulus of 25 kPa to 100 kPa at 10 Hz. Such suitable modulus indicates improvements in adhesive strength to the active material, the conductive material, and the current collector, and thus, the volume expansion and the separation of the active material from the current collector during charging and discharging may be effectively reduced or prevented. Thus, it may be expected that a battery exhibiting desired or improved cycle-life characteristics may be provided.

Whereas, Comparative Example 1 exhibited a substantially low modulus of 15 kPa at 10 Hz, which causes to exhibit low adhesive strength, thereby separating the active material from the current collector during charging and discharging, and occurring volume expansion.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims.

What is claimed is:

1. A binder for a negative electrode of a rechargeable lithium battery, the binder comprising:
a brush-like copolymer represented by Chemical Formula 1; 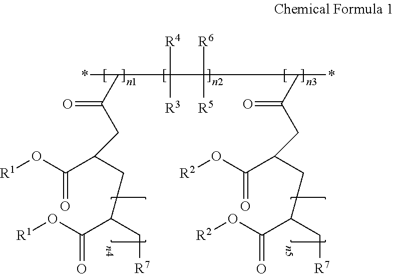
wherein R¹ and R² independently comprise hydrogen; or a substituted or unsubstituted alkyl group,
R³ to R⁶ independently comprise hydrogen; a substituted or unsubstituted alkyl group; or R^{a}COOR^{b}, wherein R^{a} is a substituted or unsubstituted alkylene group and R^{b} is a substituted or unsubstituted alkyl group;
R⁷ is hydrogen, a substituted or unsubstituted alkyl group; or CR^{d}R^{e}COOR^{f}, wherein R^{d}, R^{e}, and Rf independently comprise hydrogen; or an alkyl group;
n1 is an integer in a range of about 1 to about 10,
n2 is an integer in a range of about 2 to about 500,
n3 is an integer in a range of about 1 to about 10, and
n4 and n5 are each an integer in a range of about 10 to about 100.

2. The binder for a negative electrode of a rechargeable lithium battery of claim 1, wherein the R¹ and R² independently comprise an unsubstituted alkyl group.

3. The binder for a negative electrode of a rechargeable lithium battery of claim 1, wherein:
the alkyl group comprises a C1 to C15 alkyl group; and
the alkylene group comprises a C1 to C15 alkylene group.

4. The binder for a negative electrode of a rechargeable lithium battery of claim 1, wherein:
the alkyl group comprises one of a linear alkyl group and a branched alkyl group; and
the alkylene group comprises one of a linear alkylene group and a branched alkylene group.

5. The binder for a negative electrode of a rechargeable lithium battery of claim 1, wherein the binder has a weight-average molecular weight (Mw) in a range of about 100 kDa to about 5 MDa.

6. The binder for a negative electrode of a rechargeable lithium battery of claim 1, wherein n2 is in a range of about 10 to about 500.

7. The binder for a negative electrode of a rechargeable lithium battery of claim 1, wherein n4 and the n5 are independently in a range of about 10 to about 30.

8. A negative electrode for a rechargeable lithium battery, the negative electrode comprising:
a negative electrode active material layer comprising:
the binder of claim 1; and
a negative electrode active material.

9. The negative electrode for a rechargeable lithium battery of claim 8, wherein an amount of the binder is in a range of about 1 wt % to about 5 wt % based on a total weight of the negative electrode active material layer.

10. The negative electrode for a rechargeable lithium battery of claim 8, wherein the negative electrode active material comprises a Si-based negative electrode active material.

11. The negative electrode for a rechargeable lithium battery of claim 10, wherein the Si-based negative electrode active material comprises one of silicon and a silicon-carbon composite.

12. A rechargeable lithium battery, comprising:
a negative electrode comprising the binder of claim 1 and a negative electrode active material;
a positive electrode; and
a non-aqueous electrolyte.
